(19) United States
(12) Patent Application Publication
(10) Pub. No.: US 2009/0190738 A1
(43) Pub. Date: Jul. 30, 2009

(54) METHODS AND SYSTEMS FOR PROPAGATING INFORMATION ACROSS A NETWORK

(75) Inventors: Isaac David Guedalia, Bet Shemesh (IL); Jacob Guedalia, Newton, MA (US)

Correspondence Address: PEPPER HAMILTON LLP, ONE MELLON CENTER, 50TH FLOOR, 500 GRANT STREET, PITTSBURGH, PA, 15219, US

(73) Assignee: ISKOOT, INC., Cambridge, MA (US)

(21) Appl. No.: 12/130,419

(22) Filed: May 30, 2008

Related U.S. Application Data
(60) Provisional application No. 60/940,758, filed on May 30, 2007.
(60) Provisional application No. 60/945,931, filed on Jun. 24, 2007.

(51) Int. Cl. H04M 3/42

(52) U.S. Cl. 379/211.02

(57) ABSTRACT

A method of propagating information across a network may include receiving, from a subscriber mobile device coupled to the network, information associated with a subscriber of a service provider. The information may be sent in response to a setting change associated with the information. The method may also include identifying, from a registry, one or more contacts associated with the subscriber to whom the information should be transmitted over the network, where the one or more contacts may be included in an address book associated with the subscriber. For each identified contact, a notice associated with the information may be sent to a server node associated with the contact for propagation over the network to a mobile device associated with the contact.

### CROSS REFERENCE TO RELATED APPLICATIONS

This application claims priority under 35 U.S.C. § 119(e) to U.S. Provisional Application No. 60/940,758, filed May 30, 2007 and U.S. Provisional Application No. 60/945,931 filed Jun. 24, 2007, the entireties of which are incorporated by reference herein.

Not Applicable

### BACKGROUND

Mobile device users are commonly provided with a variety of applications designed to streamline and optimize their mobile communication experience. Amongst these are applications that allow users to view information regarding the contacts in their address books. Each user may have asocial network which may include the contacts in the user's address book, contacts of the user's contacts and so on. A user may desire to communicate and share information amongst the user's social network.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

In an embodiment, a method of propagating information across a network may include receiving, from a subscriber mobile device coupled to the network, information associated with a subscriber of a service provider. The information may be sent in response to a setting change associated with the information. The method may also include identifying, from a registry one or more contacts associated with the subscriber to whom the information should be transmitted over the network, where the one or more contacts may be included in an address book associated with the subscriber. For each identified contact, a notice associated with the information may be sent to a server node associated with the contact for propagation over the network to a mobile device associated with the contact.

In an embodiment, a system for propagating information across a network may include a subscriber mobile device associated with a subscriber of a service provider coupled to the network. The subscriber mobile device may include an address book, and the address book may include contact information associated with one or more contacts of the subscriber. The system may include a processor associated with the service provider and coupled to the network and a propagator associated with the processor. The propagator may be configured to propagate information associated with the subscriber across the network. The system may also include a computer-readable storage medium associated with the propagator that is adapted for coupling to the network and one or more server nodes coupled to the network. Each of the server nodes may be in communication with the propagator, and each of the server nodes may operate independently of any other server node. The system may include one or more contact mobile devices coupled to the network. Each of the contact mobile devices may be associated with the one or more contacts, and each of the contact devices may be in communication with at least one server node.

In an embodiment, a method of propagating a search across a network may include receiving a query from a subscriber mobile device and identifying a social network associated with the subscriber. The social network may include at least a first plurality of contacts that are one degree of separation away from the subscriber and a second set of contacts that are one degree of separation away from the first set of contacts. The method may also include for one or more contacts in the social network, searching an address book associated with the contact for a match to the query, generating a list of matches and sending the list of matches to the subscriber mobile device.

In an embodiment, a system for propagating a search across a network may include a subscriber mobile device including an address book associated with a subscriber. The address book may include one or more contacts. The system may also include a processor in communication with the subscriber mobile device and a processor-readable storage medium in communication with the processor. The processor-readable storage medium may include programming instructions for receiving a query from the subscriber mobile device, searching the subscriber's address book for matches to the query, searching an address book associated with each contact in the subscriber's address book for matches to the query, generating a list of matches, and sending the list to the subscriber mobile device.

### BRIEF DESCRIPTION OF THE DRAWINGS

Aspects, features, benefits and advantages of the present invention will be apparent with regard to the following description and accompanying drawings, of which:

FIG. 1 illustrates an exemplary social network associated with a subscriber according to an embodiment.

FIG. 2 depicts an exemplary system for propagating information across a social network according to an embodiment.

FIG. 3 illustrates a flow chart of an exemplary method of propagating information across a social network according to an embodiment.

FIG. 4 illustrates a hierarchy showing exemplary contacts having varying degrees of separation from a subscriber according to an embodiment.

FIG. 5 illustrates an exemplary social network associated with a subscriber according to an embodiment.

FIG. 6 illustrates an exemplary social network associated with a subscriber according to an embodiment.

FIG. 7 illustrates a flow chart of an exemplary method of propagating a search across a social network according to an embodiment.

FIG. 8 illustrates an exemplary system of conserving mobile device resources according to an embodiment.

FIG. 9 illustrates an exemplary method of conserving mobile device resources according to an embodiment.

### DETAILED DESCRIPTION

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

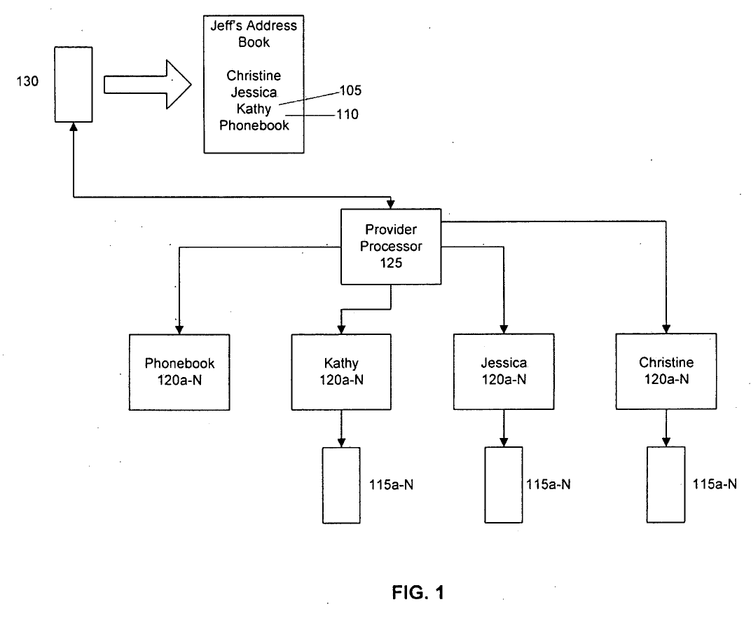

FIG. 1 illustrates an exemplary social network associated with a subscriber according to an embodiment. A subscriber may be a subscriber to a service provider. In an embodiment, a service provider may be an organization, entity and/or the like that provides one or more communication services. Exemplary service providers may include wireless service providers, voice-over Internet protocol providers (“VoIP”), mobile solution providers, mobile-to-personal computer (“PC”) communication providers and/or the like. In an embodiment, a service provider may have a corresponding wireless network. A wireless network may enable communication between a plurality of mobile devices, computing devices and/or the like. Examples of wireless networks may include computer networks, the Internet, a telephone network and/or other similar telecommunication networks.

In an embodiment, a social network may include one or more contacts associated with a subscriber, one or more contacts associated with the subscriber's contacts and so on. As illustrated by FIG. 1, a contact may be a person, an entity, a website and/or the like. For example, as illustrated by FIG. 1, Kathy 105, is a contact of a subscriber, Jeff. In addition, a website, such as an online phonebook 110, may also be a contact.

In an embodiment, one or more contacts associated with a subscriber may be included in an address book associated with the subscriber. An address book may be an application that may be accessible via a mobile device. In an embodiment, a mobile device may be a portable, electronic device that may have a processor and a processor-readable storage medium in communication with the processor. Exemplary mobile devices may include cellular phones. PDAs, media players and/or the like. In an embodiment, an address book may also be associated with an email application, a web-based application and/or the like.

In an embodiment, contact information may be stored. Contact information may include information associated with one or more contacts in an address book. For example, contact information may include one or more names, screen names, telephone numbers, email addresses and/or the like associated with one or more contacts in the subscriber's address book.

In an embodiment, a subscriber may utilize an address book associated with the subscriber's mobile device to communicate with a contact. For example, a user may access the address book application on the subscriber's mobile device and may select a contact with whom to communicate. In an embodiment, the subscriber may communicate with a contact by dialing a phone number associated with the contact directly via a landline, mobile device and/or computing device, by sending a message, such as a chat message, a text message and/or the like, and/or by other communication methods.

In an embodiment, contact information may be stored in a computer-readable storage medium located on the subscriber's mobile device. In an embodiment, contact information may be stored in a remote computer-readable storage medium associated with one or more provider processors. A provider processor may be a computing device, such as a processor, a server and/or the like, that is associated with a subscriber's mobile service provider. In an embodiment, a provider processor may send relevant information about the subscriber's contacts to the subscriber's mobile device. In an embodiment, the subscriber's mobile device may poll the provider processor to receive updated contact information. The mobile device may poll the provider processor at one or more specified intervals. For example, a subscriber's mobile device may poll a provider processor every five minutes. In an embodiment, updated contact information may be integrated into the subscriber's address book.

As illustrated by FIG. 1, computing devices 115a-N associated with one or more contacts 120a-N may communicate with a provider processor 125. A contact's computing device 115a-N may send information regarding the contact to a provider processor 125.

In an embodiment, the provider processor 125 may send information regarding the subscriber to one or more of the subscriber's contacts. In an embodiment, the provider processor 125 may receive information regarding a subscriber's contacts, and may send this information to the subscriber's mobile device 130. Updated contact information may be integrated into the address books associated with the subscriber and/or one or more contacts.

In an embodiment, information associated with a subscriber may be propagated to one or more contacts in the subscriber's social network. It is common for each service provider to have its own infrastructure and capabilities. For example, an infrastructure associated with a service provider may relay information between subscribers to the service provider and the subscribers' contacts. In an embodiment. an infrastructure may include. one or more computing devices, such as servers, processors and/or the like, one or more computer-readable storage mediums and/or the like. The computing devices within a service provider's infrastructure may communicate with each other as well as with other external communication devices to facilitate propagation of information. In an embodiment, each provider's infrastructure may store information associated with its subscribers.

In an embodiment, subscriber information may include a subscriber's contact information, presence information, subscriber availability, subscriber-provisioned information, location information and/or the like. In an embodiment, presence information may include one or more indications of whether the subscriber is online, offline and/or the like. Subscriber availability information may include one or more indications of whether the subscriber is away, unavailable, available and/or the like. For example, an icon may be displayed to a subscriber's contacts if the subscriber is currently using the mobile device to make a call. In an embodiment, subscriber-provisioned data may include information provided by the subscriber for display to one or more contacts and may include, for example, an away message, a mood message and/or the like. In an embodiment, location information may include information of the subscriber's currently location, such as zip code, time zone, city, state and/or the like.

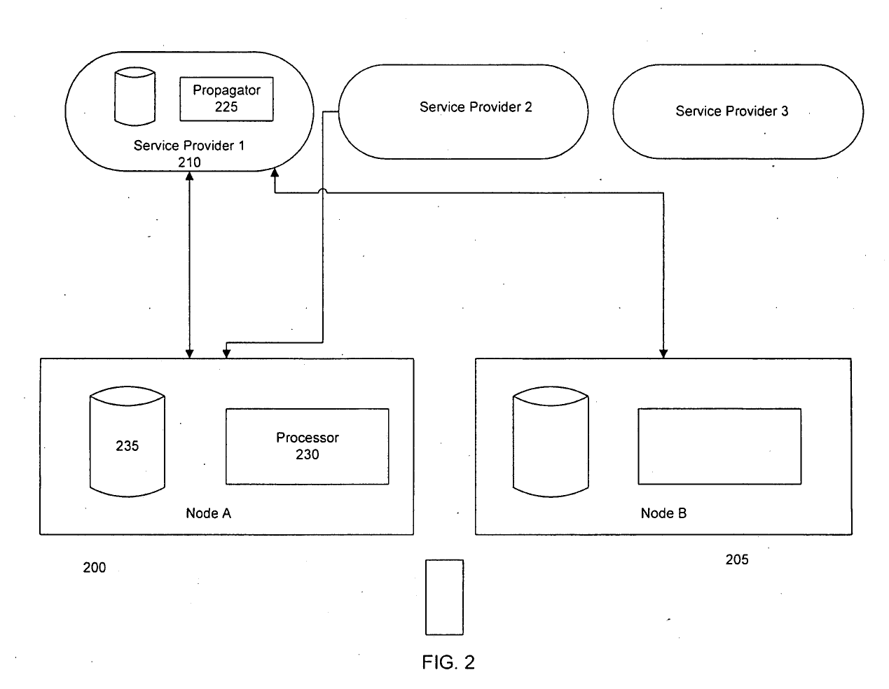

Due to high volume of subscribers and network activity, subscribers are typically assigned to one or more server nodes. As illustrated by FIG. 2, a server node 200 may include one or more processors 230, such as servers, one or more processor-readable storage mediums 235, such as databases, and/or the like. In an embodiment, a server node 200, 205 may communicate with one or more provider networks 210, 215, 220, but may not have permission and/or access to communicate with another server node 200, 205. For example, if data is received by Node A 200, Node A 200 may be unable to transmit the data to Node B 205. Node A 200 may only maintain communication with one or more provider networks 210, 215, 220. As such, each node 200, 205 may have limited access to information, data and/or the like.

In an embodiment, a provider's network 210 may include a propagator 225. A propagator may be located on one or more processors in the provider's network. Alternatively, the propagator may be a separate processor, computing device and/or the like located within the provider's network 210. The propagator 225 may be configured to propagate information to various server nodes 200, 205 for transmission to one or more mobile devices associated with one or more of the subscriber's contacts. The propagator 225 may include elements (software, hardware, or combination) that execute programming instructions. The propagator elements may include a receiving element for receiving information, a processing or identifying element where needing to identify features and a sending element for sending information. The information may be passed to and from the propagator 225 or associated processor or storage mediums by way of a network such as a wireless network or a network including a combination of wireless and wired portions thereof.

Examples of information that may be propagated may include subscriber information, as described above, information associated with one or more settings on a mobile device and/or any other information sent to the provider's network by a subscriber's mobile device. In an embodiment, information may be sent by a mobile device in response to a setting change associated with the mobile device. A mobile device setting may be a configuration associated with one or more features of the mobile device. In an embodiment, a setting change may be modified by a user. For example, a setting change may include a change in one or more of a ringtone, a ring type, an availability, a presence, a location and/or the like. A setting change may also include an indication that a subscriber is sending a message, such as a text message or a chat message, an indication that the subscriber is on a telephone call, and/or the like.

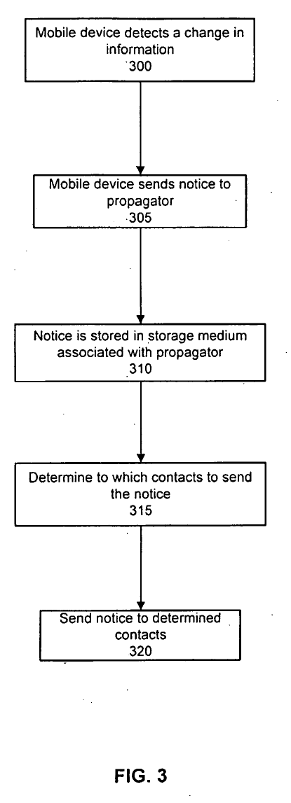

FIG. 3 illustrates a flow chart of an exemplary method of propagating information across a social network according to an embodiment. In an embodiment, a subscriber's mobile device may detect 300 a setting change, and may send 305 information associated with the setting change to a propagator associated with the subscriber's service provider.

In an embodiment, the information may be sent 305 to a sever node associated with the subscriber. The information may be sent 305 from the server node to a propagator associated with the subscriber's service provider for propagation to one or more of the subscriber's contacts. In an embodiment, the information may be stored 310 in a computer-readable storage medium associated with the propagator. In an embodiment, the propagator may include a registry of one or more subscribers' contacts and to which server node the contacts are associated. In an embodiment, the registry may also include an indication of the type of information that is to be propagated to each contact. For example, a first contact associated with a subscriber may want to be alerted when the subscriber comes online. A second contact may want to be alerted when the subscriber changes an away message. A third contact may not want to receive any information. As such, the propagator may access the registry to determine 315 what information is to be sent to what contact. In an embodiment, all the information to be propagated may be sent 320 to every contact associated with the subscriber. Table 1 illustrates an exemplary registry associated with Subscriber 1.

TABLE 1
Subscriber 1

| Contact | Node | Information to be Sent |
|---|---|---|
| Contact 1 | Node A | Presence information |
| Contact 2 | Node B | Availability information |
| Contact 3 | Node C | No information |

In an embodiment, the propagator may use its registries to determine 315 to which server node the information is to be propagated. For example, if Subscriber 1 comes online, subscriber availability information may be transmitted 305 from Subscriber 1's mobile device to a propagator associated with Subscriber 1's service provider. The propagator may store 310 Subscriber 1's availability information in an associated computer-readable storage medium. The propagator may determine 315 which of Subscriber 1's contacts are to be alerted when Subscriber 1 changes availability information and the server nodes associated with those contacts. As illustrated by Table 1, Contact 2 is to receive notice of a change in Subscriber 1's availability information, so the propagator may send 320 availability information associated with Subscriber 1 to Node B for distribution to a mobile device and/or computing device associated with Contact 2.

In an embodiment, the propagator may maintain a list of instances, where each instance may include information to be sent, a server node to which the information is to be sent, a contact associated with the node and/or the like. When information is successfully transmitted to a server node, the propagator may remove the corresponding instance from its list. In an embodiment, the propagator may continue to send the information until the information is successfully transmitted. In an embodiment, a notice may be displayed on the subscriber's mobile device advising the subscriber that updated information has been propagated to one or more contacts.

In an embodiment, when a server node receives information from a propagator, the server node may transmit the information and/or a notification associated with the information to a computing device associated with corresponding contact. For example, referring to the above example, Node B may receive subscriber availability information associated with Subscriber 1 from the propagator and may send the information to a computing device associated with Contact 2. A notice that Subscriber 1 is now available may be displayed on Contact 2's computing device.

In an embodiment, a service provider, propagator, wireless network and/or the like may be unavailable to a subscriber. For example, a subscriber may be offline, there may exist a lack of connectivity and/or the like. If a mobile device detects unavailability, the mobile device may allow the subscriber to communicate using standard call features such as direct dial and/or the like.

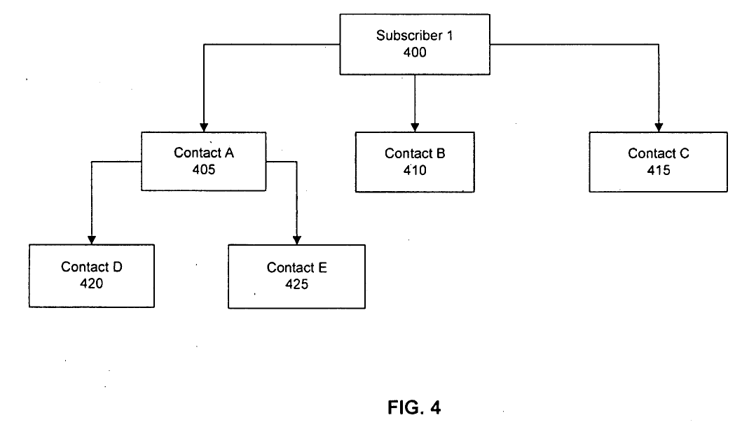

In an embodiment, a subscriber may propagate a search for information across the subscriber's social network. In an embodiment, the address books associated with one or more contacts of a certain degree of separation away from the subscriber may be searched. FIG. 4 illustrates a hierarchy showing exemplary contacts having varying degrees of separation from a subscriber according to an embodiment. As illustrated by FIG. 4, an address book associated with a subscriber, Subscriber 1 400, may include contact information for three contacts: Contact A 405, Contact B 410 and Contact C 415. These three contacts 405, 410, 415 may be considered contacts that have one degree of separation from Subscriber 1 400. In an embodiment, Contact A's address book may include contact information for two contacts: Contact D 420 and Contact E 425. Contact D 420 and Contact E 425 may be considered contacts that have two degrees of separation from Subscriber 1 400 and one degree of separation from Contact A 405.

In an embodiment, a subscriber, using a mobile device may search for contact information associated with a target. A target may be a person, an entity, a website and/or the like. For example, a subscriber may use his mobile device to search for information associated with Target A. In an embodiment, the subscriber may enter a query on his mobile device. The query may include information associated with the target such as a name, a portion of a name, a screen name, a phone number and/or other identifiers. In an embodiment, the query may include a certain degree of separation from the subscriber. For example, a subscriber may limit the search to contacts that are two degrees of separation away from the subscriber.

In an embodiment, the query may be sent to one or more processors associated with the subscriber's service provider. The processors may search the susbcriber's address book and/or the address books associated with one or more of the subscriber's contacts for a match. For example, in an embodiment, the query may be sent to a propagator associated with the subscriber's service provider. In an embodiment, the query may be sent to a propagator via a server node.

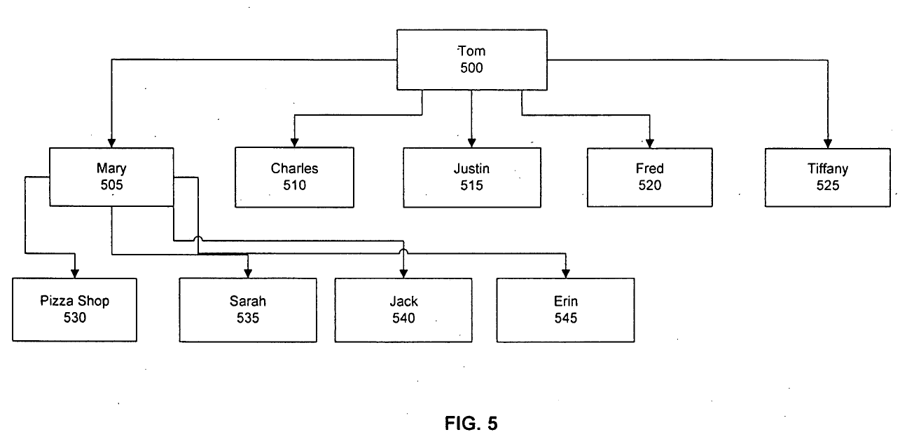

For example, FIG. 5 illustrates a social network associated with a subscriber, Tom 500. As illustrated by FIG. 5. Tom 500 has five contacts that are one degree of separation away from tom 500: Mary 505, Charles 510, Justin 515, Fred 520 and Tiffany 525. In turn, Mary 505 has four contacts that are one degree of separation away from Mary 505, and two degrees of separation away from Tom 500: Pizza Shop 1 530, Sarah 535, Jack 540 and Erin 545.

In an embodiment, Tom 500 may want to call Sarah 535. However, Tom 500 may not have Sarah's contact information. In an embodiment, if Tom 500 knows that Sarah 535 is a contact of Mary's, Tom 500 may search Mary's address book for Sarah's information using at least a portion of Sarah's name, screen name and/or other identifier. In an embodiment, if Tom 500 does not know to which of his contacts' address books Sarah 535 belongs, he may search the address books associated with his social network for Sarah's contact information.

In an embodiment, a subscriber may specify a certain degree of separation associated with a search. For example, Tom 500 may limit his search to contacts that are one or two degrees of separation away from Tom 500. In this case, the address books associated with contacts that are one degree of separation away from Tom 500 may be searched.

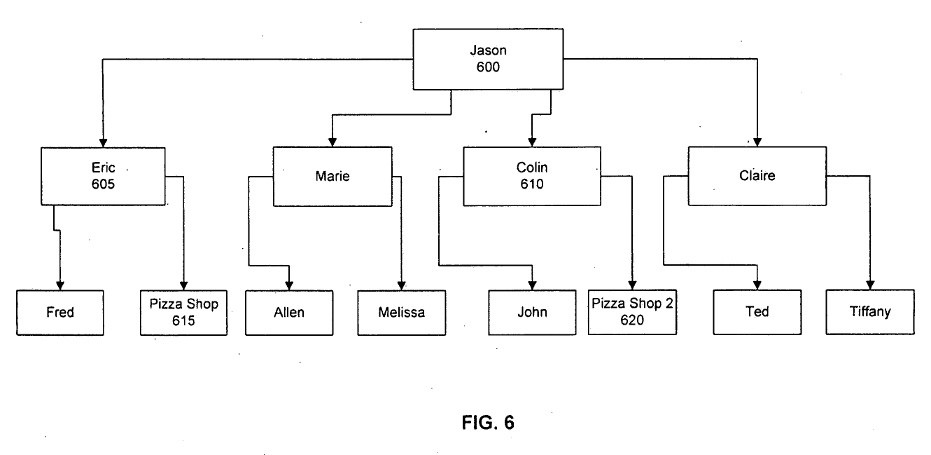

In an embodiment, a subscriber may propagate a cross-address book search for one or more keywords, keyword phrases and/or the like. For example, a subscriber's query may include a specific word or phrase, such as “pizza.” The subscriber's mobile device may send the query to a provider computing device, which may search for the keyword or key phrases within the address books of the subscriber's contacts and/or the address books of the contacts that are a certain degree of separation away from the subscriber. For example, as illustrated by FIG. 6, a subscriber, Jason 600, may submit a query for the keyword “pizza.” A provider computing device may search the address books of contacts a certain degree of separation away from Jason 600. For example, the address books associated with contacts that are one degree of separation of Jason 600 may be searched.

As illustrated by FIG. 6, two contacts that are one degree of separation away from Jason (i.e., Eric 605 and Colin 610) have contact information for pizza shops (i.e., Pizza Shop 1 615 and Pizza Shop 2 620) in their address books. The provider processor may send contact information associated with Pizza Shop 1 615 and Pizza Shop 2 620 to Jason's mobile device. In an embodiment, this information may include the name of the pizza shop, the phone number of the pizza shop, an address of the pizza shop and/or the like. As this example illustrates, a subscriber may have access to certain recommendations (in this case, recommendations of pizza shops) by searching address books associated with the subscriber's social network for pizza-related entries, which presumably represent the contacts' favorite pizza shops.

In an embodiment, the provider processor may search one or more phone books for the query keywords and/or phrases. For example, referring to FIG. 6, Eric 605 has an online Boston phonebook 625 as a contact in his address book. If Jason 600 searches for “pizza,” the computing device may search the online Boston phonebook 625 for listings that match pizza. In an embodiment, the computing device may automatically search one or more phone books for query keywords and/or phrases even if the phone book is not listed as a contact in an address book in a subscriber's network. In an embodiment, the provider processor may search one or more phone books associated with the subscriber's location. For example, if Jason 600 is in Manhattan, the provider computing device may search one or more online Manhattan phone books for entries matching the word “pizza.”

In an embodiment, a current location associated with the subscriber may be determined. In an embodiment, one or more address books associated with one or more contacts that are within a defined range of the current location may be searched.

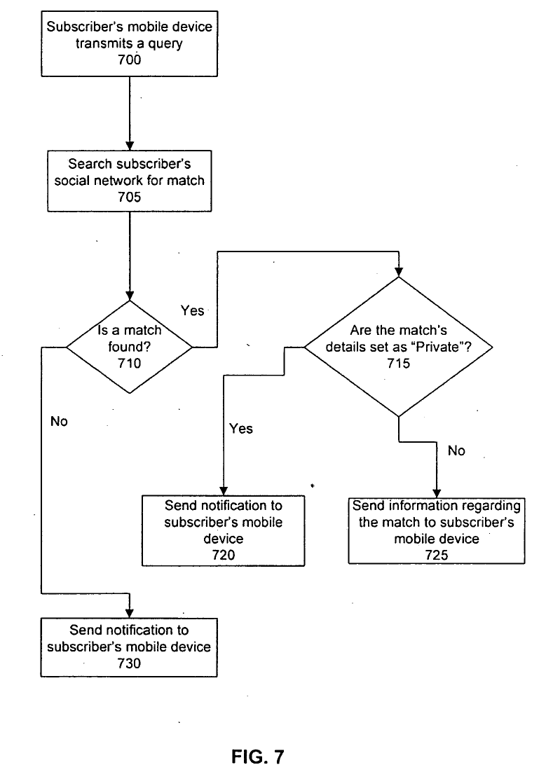

FIG. 7 illustrates a flow chart of an exemplary method of propagating a search across a social network according to an embodiment. In an embodiment, the subscriber's mobile device may transmit 700 a query to a provider processor. In an embodiment, the provider processor may search 705 among the subscriber's social network to find a match between the target and one or more entries in the searched address books. For example, the provider processor may search 705 the subscriber's address book for contacts matching the query. If the query specified a degree of separation, the computing device may search 705 the address books of contacts that are the specified degree of separation away from the subscriber.

In an embodiment, a search may be conducted across all available networks. For example, a subscriber may belong to one service provider, but may have contacts that belong to a different service provider. In an embodiment, the address books associated with the subscriber's contacts may be searched even though they may be associated with a different service provider.

In an embodiment, if the provider processor locates 710 a contact that matches the subscriber's query, the provider processor may determine 715 whether the details associated with the match are designated as “Private” or otherwise require permission to access.

In an embodiment, a subscriber may set preferences for how the subscriber's address book may be searched and what information can be disclosed. For example, a subscriber may set one or more contact's details as “Private” meaning that these details may not be shared or disclosed. In an embodiment, if a search encounters a target that is a potential match to a query whose contact information is designated “Private,” the provider processor may be notified. In an embodiment, if the details associated with a match are designated as “Private,” the provider processor may send 720 a message to the querying subscriber's mobile device that notifies the subscriber that a target has been located but that the target's contact details are designated “Private.” In an embodiment, the message may include information associated with the contact in whose address book the target was found.

In an embodiment, if the details associated with a match are not designated as “Private,” the provider processor may send 725 a notification to the subscriber's mobile device. In an embodiment, a list of matches may be sent to the subscriber's mobile device. The provider processor may send 725 contact information associated with the one or more located contacts to the subscriber's mobile device. The information may include a name, a phone number, a screen name and/or the like associated with the located contact. The information may also include the name of the contact in whose address book the located contact was located. For example, referring to FIG. 6, Tom 600 may search for “Sarah” within address books associated with contacts having one degree of separation from Tom 600. As such, the address books associated with Mary 605, Charles 610, Justin 615, Fred 620 and Tiffany 625 may be searched. Contact information associated with Sarah 635 may be located in Mary's address book, and this information may be sent to Tom's mobile device along with an indication that the information was located in Mary's address book.

In an embodiment, the results may be displayed on the subscriber's mobile device according to the contact network in which they were located. A contact network may refer to a contact associated with the subscriber, such as a contact that is one degree of separation away from the subscriber, a website that was searched, such as a phone book, and/or the like. In an embodiment, the provider computing device may send 730 a notification to the subscriber's mobile device if no matches were located.

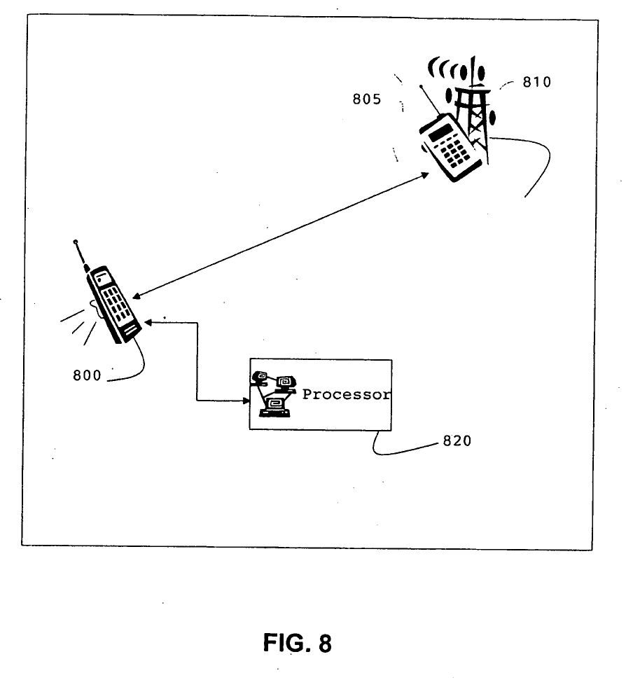

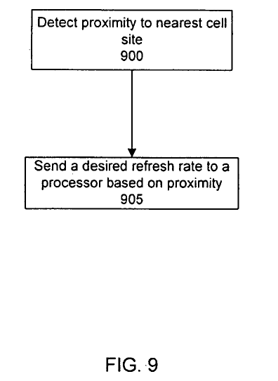

In an embodiment, resources associated with a mobile device may be conserved. In an embodiment, resources may include battery power and/or the like. FIG. 8 illustrates an exemplary system of conserving mobile device resources in an embodiment. FIG. 9 illustrates an exemplary method of conserving mobile device resources according to an embodiment.

As illustrated by FIG. 8, a mobile device 800 may communicate with a cell site 805. In an embodiment, a cell site 805 may be an area that includes one or more antennas and electronic communication equipment that facilitate communication over a wireless network. A cell site 805 may include a tower or other elevated structure, one or more transmitters, one or more receivers, one or more transceivers, one or more processors, one or more power sources and/or the like. As illustrated by FIG. 8, a cell site 805 may include a cell tower 810.

In an embodiment, battery power usage of a mobile device 800 may fluctuate based on the proximity of the mobile device 800 to the cell site 805. For example, the closer the mobile device 800 is located to the cell site 805, the less battery power is consumed. In contrast, the further the mobile device 800 is located from the cell site 805, the more battery power is consumed.

In an embodiment, a mobile device 800 may maintain a two-way communication channel with a processor 815. In an embodiment, the processor 815 may be associated with a subscriber's service provider. In an embodiment, a mobile device 800 may include one or more sensors that may detect 900 the proximity of the mobile device 800 to the closest cell site. Information received by the sensors may be communicated to the mobile device 800. In an embodiment, the mobile device 800 may send 905 a desired refresh rate to the processor. In an embodiment, the desired refresh rate may be determined based on the information communicated to the mobile device 800 from the sensors. In an embodiment, the desired refresh rate may be determined to optimize the preservation of mobile device resources. For example, if a mobile device 800 is located relatively close to a cell site 805, the mobile device 800 may instruct the process to engage in a high refresh rate. In contrast, if a mobile device 800 is located relatively far from a cell site 805, the mobile device 800 may instruct the processor 815 to engage in a low refresh rate to conserve resources.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of propagating information across a network, the method comprising:
receiving, from a subscriber mobile device coupled to the network, information associated with a subscriber of a service provider, said information being sent in response to a setting change associated with the information;
identifying, from a registry, one or more contacts associated with the subscriber to whom the information should be transmitted over the network, said one or more contacts being included in an address book associated with the subscriber; and
for each identified contact, sending a notice associated with the information to a server node associated with the contact for propagation over the network to a mobile device associated with the contact.

2. The method of claim 1, wherein the identifying one or more contacts comprises:
accessing the registry associated with the subscriber, said accessing including accessing contact information associated with each identified contact in the address book, accessing an indication of a server node associated with each identified contact, and accessing an indication of the type of information to be sent to each identified contact; and
for each identified contact, determining whether a type associated with the received information corresponds to the type of information associated with the contact.

3. The method of claim 1, wherein the sending a notice comprises:
determining whether the notice was successfully received by the server node; and
removing the notice from a list of outstanding communications.

4. The method of claim 1, further comprising:
displaying a notice on the subscriber mobile device advising the subscriber that updated information has been propagated to the one or more contacts.

5. A system for propagating information across a network, the system comprising:
a subscriber mobile device associated with a subscriber of a service provider coupled to the network, said subscriber mobile device including an. address book, and said address book including contact information associated with one or more contacts of the subscriber;
a processor associated with the service provider and coupled to the network;
a propagator associated with the processor, said propagator being configured to propagate information associated with the subscriber across the network;
a computer-readable storage medium associated with the propagator, adapted for coupling to the network;
one or more server nodes, coupled to the network, each of said server nodes being in communication with the propagator, and each of said server nodes operating independently of any other server node; and
one or more contact mobile devices coupled to the network, each of said contact mobile devices being associated with the one or more contacts, each of said contact devices being in communication with at least one server node.

6. The system of claim 5, wherein the subscriber mobile device is configured to send information associated with the subscriber to the propagator in response to a setting change associated with the information.

7. The system of claim 5. said propagator comprising:
a receiving element configured to receive information associated with the subscriber from the subscriber mobile device;
an identification element configured to identify a contact from the one or more contacts who is to be alerted as to the received information; and
a sending element configured to send a notice to the server node associated with the identified contact.

8. The system of claim 5, wherein each server node comprises:
a receiving element configured to receive a notice from the propagator, wherein the notice is associated with a contact associated with the server node; and
a sending clement configured to send the notice to the mobile device associated with the contact.

9. The system of claim 5, wherein the subscriber mobile device is configured to display an alert that updated information has been propagated to the one or more contacts.

10. A method of propagating a search across a network, the method comprising:
receiving a query from a subscriber mobile device;
identifying a social network associated with the subscriber, said social network comprising at least a first plurality of contacts that are one degree of separation away from the subscriber and a second set of contacts that are one degree of separation away from the first set of contacts;
for one or more contacts in the social network, searching an address book associated with the contact for a match to the query;
generating a list of matches; and
sending the list of matches to the subscriber mobile device.

11. The method of claim 10, the receiving comprising one or more of the following:
receiving at least a portion of a name;
receiving a screen name;
receiving a phone number;
receiving a keyword; and
receiving a key phrase.

12. The method of claim 10, said at least one contact in the social network belonging to a different service provider than the subscriber.

13. The method of claim 10, the step of generating comprising:
for each match, determining whether contact information associated with the corresponding contact is classified as private; and
excluding matches associated with private contact information from the list.

14. The method of claim 10, said sending the list to the subscriber mobile device step comprising:
sending a message to the subscriber mobile device, said message notifying the subscriber that at least one match has been excluded, and said message comprising information associated with the contact in whose address book each excluded match was located.

15. the method of claim 10, said searching an address book step comprising:
determining a current location associated with the subscriber; and
searching one or more address books associated with one or more contacts that are within a defined range of the current location.

16. The method of claim 10, wherein said sending the list step comprising sending a notification if no matches are found.

17. The method of claim 10, said list comprising one or more of the following for each match:
a name associated with the match;
a phone number associated with the match;
a screen name associated with the match; and
a name associated with the contact in whose address book the match was located.

18. A system for propagating a search across a network, the system comprising:
a subscriber mobile device comprising an address book associated with a subscriber, the address book comprising one or more contacts;
a processor in communication with the subscriber mobile device; and
a processor-readable storage medium in communication with the processor, wherein the processor-readable storage medium comprises programming instructions for:
receiving a query from the subscriber mobile device,
searching the subscriber's address book for matches to the query,
searching an address book associated with each contact in the subscriber's address book for matches to the query,
generating a list of matches, and
sending the list to the subscriber mobile device.

19. The system of claim 18, said programming instructions for generating a list of matches comprising:
for each match, programming instructions for determining whether contact information associated with the corresponding contact are classified as private; and
programming instructions for excluding matches associated with private contact information from the list.

20. The system of claim 18, said programming instructions for sending the list to the subscriber mobile device comprising:
programming instructions for sending a message to the subscriber mobile device, said message notifying the subscriber that at least one match has been excluded, and said message including information associated with the contact in whose address book each excluded match was located.

21. The system of claim 18, said programming instructions for searching an address book comprising:
programming instructions for determining a current location associated with the subscriber; and
programming instructions for searching one or more address books associated with one or more contacts that are within a defined range of the current location.

22. The system of claim 18, said programming instructions for sending the list comprising programming instructions for sending a notification if no matches are found.
